(19) United States
(12) Patent Application Publication
(10) Pub. No.: US 2006/0212806 A1
(43) Pub. Date: Sep. 21, 2006

(54) Application of presentation styles to items on a web page

(75) Inventors: William J. Griffin, Sammamish, WA (US); George Perantatos, Seattle, WA (US); Christopher Edward White, Seattle, WA (US); Boxin Li, Bellevue, WA (US); Shailja S. Nair, Sammamish, WA (US); Nathan James Fink, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/083,563

(22) Filed: Mar. 18, 2005

(51) Int. Cl. G06F 17/00

(52) U.S. Cl. 715/523

(57) ABSTRACT

Methods and systems provide for application of style properties/settings to one or more web page items, components, links, or other web page content. Use of an edit menu allows for the application of a selected style setting on a per-item basis or on an all-item basis and allows for the provision of a preview of the application of a selected style setting to a selected web page item. Through the use of a web page editing user interface, style settings may be applied to web page items through drag and drop operations and through application via conventional style setting application methods such as highlighting a selected web page item, followed by selection of a desired style setting.

### FIELD OF THE INVENTION

The present invention generally relates to organization and presentation of content on a web page. More particularly, the present invention relates to application of presentation styles to items on a web page.

### BACKGROUND OF THE INVENTION

With the advent of the computer age, computer and software users have grown accustomed to user-friendly software applications that help them write, calculate, organize, prepare presentations, send and receive electronic mail, make music, and the like. For example, modem electronic word processing applications allow users to prepare a variety of useful documents. Modem spreadsheet applications allow users to enter, manipulate, and organize data. Modem electronic slide presentation applications allow users to create a variety of slide presentations containing text, pictures, data or other useful objects. Internet and intranet browsing applications allow users to navigate to a variety of useful pages for viewing or interacting with information on numerous topics.

Typical web pages often include information such as text, images, music, and the like associated with one or more topics. In addition, many web pages include links to various resources either contained on the same web page as a given link or contained on a different web page that may be navigated to by selection of the given link. Web page authors and editors strive to present web page content and links in presentation styles and formats that are appealing to users and that make navigation of the content and links on the web page more efficient and user-friendly. According to prior methods and systems, web page authors/editors, desiring to edit the presentation styles applied to one or more web page items, must launch some type of web page editing application that allows edits to the entire web page. Once in such an edit mode, the web page author/editor is typically stuck with a small set of “out-of-the-box” style properties that may be applied to the web page content. Adding additional style properties involves manually writing a custom server control to affect the desired property.

According to such prior methods and systems, web page authors/editors may not apply style properties to a single item in a web page control that is different from style properties applied to neighboring items in the same control. For example, if a given web page control or part includes four links to web page resources, prior methods and systems do not allow for efficiently applying one style (e.g., bold text) to one link while maintaining a different style (e.g., italicized text) for the other links in the control. In addition, prior methods and systems do not allow an author to quickly and easily apply the same look and feel to a group of items and enforce that look and feel on new items—the author must do this manually.

Accordingly, there is a need for a more efficient and user-friendly method of applying style properties to web page content. There is further a need for methods and systems for allowing both per-item and all-item style editing for web page content through an edit menu that allows for the application and preview of a desired style to a given item or set of items before actually making changes to the web page presentation. It is with respect to these and other considerations that the present invention has been made.

### SUMMARY OF THE INVENTION

Embodiments of the present invention solve the above and other problems by providing methods and systems for applying various style properties to web page content on a per-item or all-item basis via an edit menu. A preview of applied style properties is provided in the edit menu prior to actually making a given style property change to one or more web page items.

According to one embodiment of the present invention, an edit menu allows a web page author/editor to apply a desired style property to a given web page item apart from neighboring items. The edit menu provides a preview of a presentation view of the item if the selected style property is actually applied to the selected item. Style properties applied to a given web page item may be shared and/or reused across web page controls on a given web site. The available set of styles for items on a web page can be controlled by a web site administrator, giving a page author the ability to choose only one of an approved set of available styles for a page element.

According to another embodiment of the present invention, web page content is formatted according to the Extensible Markup Language (XML). Each available style property that may be applied to a given web page item is implemented as an Extensible Stylesheet Language (XSL) transformation that may be used to transform a given web page item to a web page presentation format, for example, Hypertext Markup Language (HTML), while applying one or more selected style properties to the web page item during the transformation.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 is a block diagram showing the architecture of a personal computer that provides an illustrative operating environment for embodiments of the present invention.

FIG. 2 illustrates a computer screen display of an Internet-based web page showing example web page content according to embodiments of the present invention.

FIG. 3 illustrates a computer screen display of an edit menu for applying a style property to a selected web page item according to embodiments of the present invention.

FIG. 4 illustrates a computer screen display of a number of web page items to which style properties may be applied according to embodiments of the present invention.

FIG. 5 illustrates a computer screen display of a user interface with which editing of style properties and web content may be accomplished according to embodiments of the present invention.

FIG. 6 is a flow diagram showing an illustrative routine for editing style properties applied to web page items according to embodiments of the present invention.

FIG. 7 is a flow diagram showing an illustrative routine for applying style properties to web page items via a web page editing application and via drag and drop operations according to embodiments of the present invention.

### DETAILED DESCRIPTION

As briefly described above, embodiments of the present invention are directed to application of style properties to web page items on a per-item or all-item basis. An edit menu may be utilized for applying a style property to one or more web page items. The edit menu provides a preview of a presentation view of a given web page item according to a selected style property before actually committing to the application of the selected style property. In addition, style properties may be applied to a given web page item by dragging the web page item from one location in a web page to a second location in a web page where the second location in a web page is associated with one or more different style properties. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

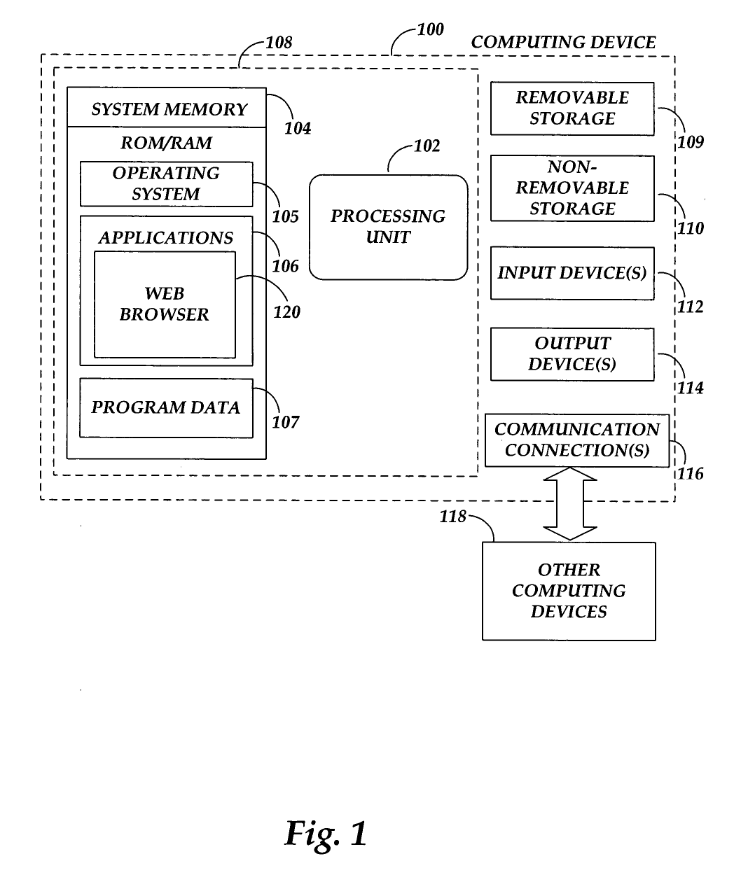

Referring now to the drawings, in which like numerals refer to like elements through the several figures, aspects of the present invention and an exemplary operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system for implementing the invention includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 may include a web browsing application 120, such as INTERNET EXPLORER®, manufactured by MICROSOFT CORPORATION. This basic configuration is illustrated in FIG. 1 by those components within dashed line 108.

The computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well know in the art and need not be discussed at length here.

Computing device 100 may also contain communication connections 116 that allow the device to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

A number of program modules and data files may be stored in the system memory 104 of the computing device 100, including an operating system 105 suitable for controlling the operation of a networked personal computer, such as the WINDOWS operating systems from MICROSOFT CORPORATION of Redmond, Washington. System memory 104 may also store one or more program modules, such as word processor application 120, and others described below. The web browsing application 120 is operative to provide functionality for viewing, editing, and processing electronic information via one or more Internet-based or other network-based web pages. In addition, as described herein, web page content is edited in a web page editing mode. Web page editing may be performed via an editing mode of the web browsing application 120, or via another suitable web page editing application or tool may be programmed for allowing editing of a web page via a drag and drop operation described herein. Other applications 106 that may be used in accordance with embodiments of the present invention include electronic mail and contacts applications, word processing applications, spreadsheet applications, database applications, slide presentation applications, drawing or computer-aided application programs, etc.

According to embodiments of the present invention, display styles or style properties that may be applied to various web page items such as web page content, including web page links, are defined as Extensible Stylesheet Language (XSL) definitions. According to this embodiment of the present invention, web page content, including web page links, is structured according to the Extensible Markup Language (XML). Thus, each available style property that may be applied to a given web page item is implemented as an XSL transformation that may be used to transform a given XML-formatted web page item to a web page presentation format, such as Hypertext Markup Language (HTML) while applying one or more selected style properties to the web page item during the transformation.

Each XSL transformation file can define one or more XSL templates. The XSL templates define a “style ” for an item, including the fonts, colors, and layout of the content associated with the web page item. According to one embodiment, styles are available on a per web site basis which means that styles for a given web portal site may be centrally defined and available for all areas of the web site. For example, a “headline” style may be used for a first area of a web site and the same “headline” style may be used for a second area of the same web site. According to one embodiment, the XSL files may be stored in a top-level document library for access by a given web site or web page during an editing mode.

According to embodiments of the present invention, the operation of setting a style property on a given web page item within a group of web page items may accomplish a number of operations. The display of the affected web page item may be changed, including what properties are shown, how the properties are shown, and how the properties are laid out relative to each other. The operation of setting a style property on a web page item may remove any styling associated with a group of web page items where the group has set a particular styling property on all listings or items in the group. In other words, applying a style property to one web page item in a group of web page items may disable group-level styles applied to all items in the group. However, other items in the group may remain as-is with existing style properties as previously applied by the group-level style properties.

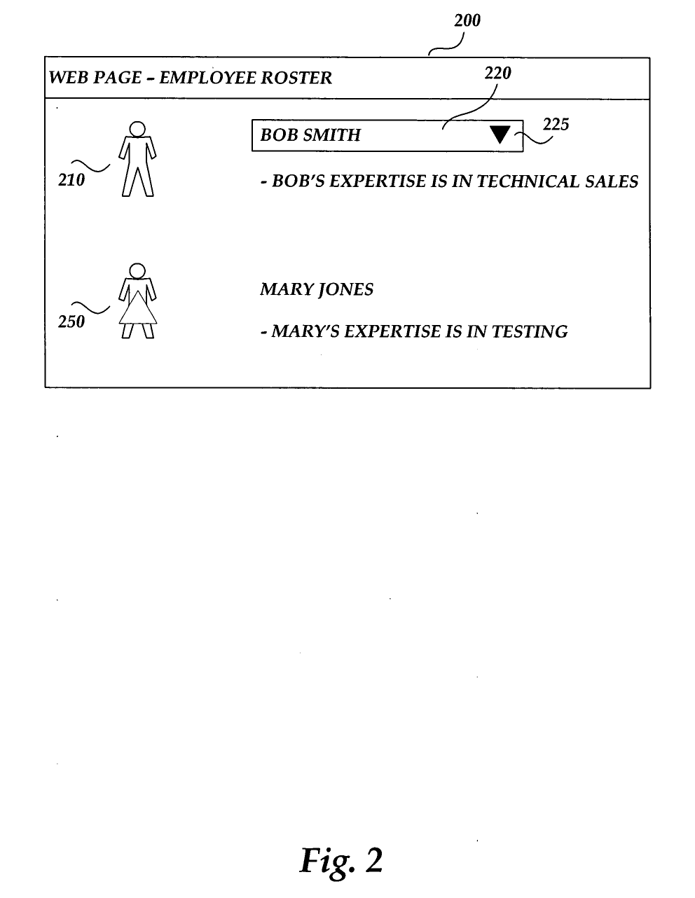

Referring to FIG. 2, an example web page is illustrated having two web page items, 210, 250. For example, the web page 200 may be an example employee roster page having a web page item for each employee in an organization. For example, the web page item 210 includes an image associated with employee “Bob Smith” and a description of Bob's expertise underneath the title of the web page item “Bob Smith.” As should be appreciated by those skilled in the art, one or more portions of the web page item 210 may include a link to resources on the same web page 200 or to resources on a separate web page. For example, the title “Bob Smith” of the first web page item 210 may be a link which, when selected, causes navigation to personal information for the example employee, such as full name, address, telephone number, personnel information, and the like. Likewise, the descriptive portion of the web page item 210 may be in the form of a web page link which, when selected, causes navigation to a resource providing a more detailed description of the example employee's expertise for the example company. As should be understood by those skilled in the art, the web page illustrated in FIG. 2, along with the example web page items and information, is for purposes of illustration only and is not limiting of the vast number of web page types and web page content to which embodiments of the present invention may be applied.

According to an embodiment of the present invention, a web page author/editor may select an entire web page element listing (title, description, image, URL, etc.) and style the selected element with one of a set of available style templates having a set of properties, for example, bold, title only, centered, blue. Referring to FIG. 2, if a web page author/editor desires to apply or revise style settings or properties applied to one or more of the given web page items 210, 250, the web page author/editor may selectively activate an edit menu for application of style properties while in an edit mode for a given web page. For example, according to embodiments of the present invention, a web page author/editor may selectively enter a web page editing mode by selecting a tool or button such as “configure styles,” “edit web page,” or the like. Or, the author/editor may launch a web page editing application programmed for applying styles according to embodiments of the present invention. As should be understood by those skilled in the art, a variety of different means for accessing a web page edit mode may be provided by different web browsing applications and web page editing applications for editing a given web page.

Referring still to FIG. 2, once the web author/editor has selectively engaged the edit mode for the example web page 200, the web page author/editor may expose an edit menu for applying style properties to web page objects by focusing on or hovering over a given web page item that the author/editor desires to edit. According to one embodiment of the present invention, the author/editor may be required to select a functionality control such as “set styles” from the web page editing mode prior to focusing on a given web page item. As illustrated in FIG. 2, once a particular web page item 210 is focused on or hovered over, for example, a style properties menu entry point 220 appears about the focused-on web page item. As illustrated in FIG. 2, an example menu entry point 220 includes a down arrow 225 with which an author/editor may selectively deploy an edit menu for applying a selected style to the selected web page item.

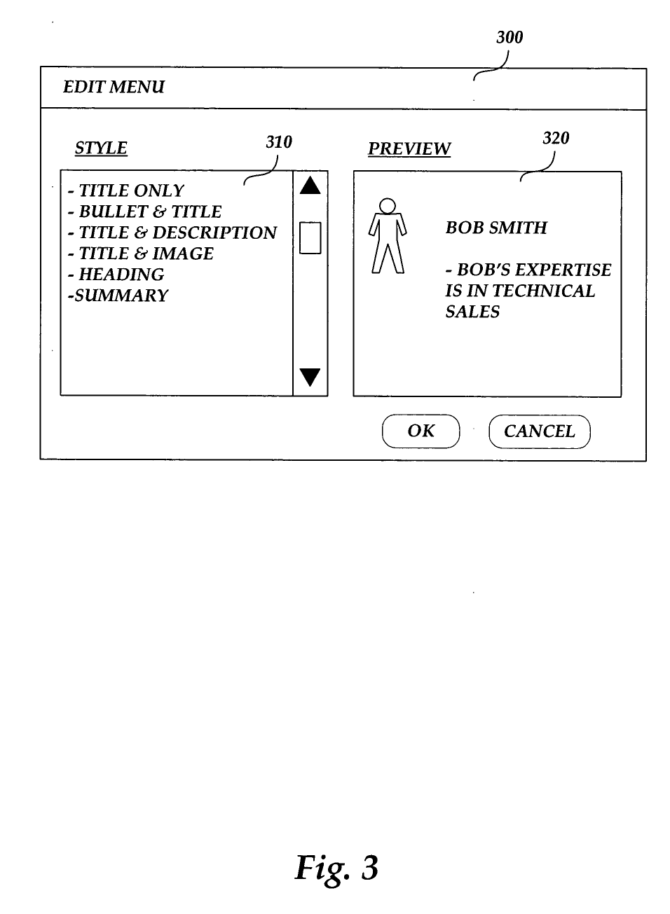

Referring to FIG. 3, an example screen display of an edit menu 300 for applying one or more style properties to the selected web page item is illustrated. On the left-hand side of the user interface 300, a style property selection window 310 is provided for providing one or more available style properties that may be applied to the selected web page item. As described above, according to embodiments of the present invention, each available style property is associated with an XSL transformation file for transforming XML-formatted web page items to a web page presentation format bearing a style property associated with the selected XSL transformation file.

Before selecting a desired style property, the author/editor first selects a web page item for application of a selected style property. Once a web page item is selected for style application, the window 310 is populated with available style names that may be applied to the selected web page item. For example, “a title only” style, “a bullet and title” style, “a title and description” style, “a title and image” style, “a heading” style, and “a summary” style are available for selection by the author/editor for applying a selected style property to a desired portion of the web page item. As should be understood, a variety of different web page styles may be provided in the style selection window 310. According to this embodiment the provided styles are XSL templates for structuring a selected web page item according to a variety of styles, for example, outline style, bullet style, and the like.

According to embodiments of the present invention, selection of certain style properties may allow for a customization of style properties to be applied to one or more portions of a given web page item, for example, varying font sizes, colors, font types, text positions (justified versus centered), and the like. As described above, each potential style property that may be applied to one or more portions of the selected web page item is associated with an XSL definition that will be utilized for transforming the selected web page item or portion thereof into a web page presentation format bearing a style associated with the selected style property.

As illustrated in FIG. 3, on the right-hand side of the user interface 300, a preview window or pane 320 is provided for displaying a preview of the selected web page item as the web page item will be displayed in a final web page if a selected style property is applied to the web page item. For example, if the author/editor first selects the “title only” style for the web page item, a preview of the selected web page item will be provided in the preview window 320 structured/formatted according to the selected style.

According to embodiments of the present invention, once the author/editor selects a given style property for application to a selected web page item, the preview displayed in the preview pane 320 is dynamically updated to show how the selected web page item will appear in the web page if the selected style property is committed to the selected web page item. Thus, an author/editor may try a number of different style properties and receive a preview of each different style property before actually committing a change to the web page containing the web page item selected by the author/editor. Once the author/editor decides on a particular style property to be applied to one or more portions of a given web page item, the author/editor may accept changes, and the accepted changes will be applied to the selected web page item in the selected web page.

According to one embodiment of the present invention, once the author/editor selects application of a particular style property to a particular portion of a given web page item, for example, the “title” of a web page item, the XSL style definitions may be updated in the top-level document library, described above, such that all “titles” for all web page items in the selected web page or on a selected web site containing the selected web page may be subsequently styled according to the updated style property for “titles” when the XML-formatted web page content is transformed for presentation in the web page. Alternatively, style properties selectively applied to a given portion of a given web page item, for example, the “title” of a given web page item, may be applied on an individual web page item basis without affecting style properties applied to other similar web page item portions in a given web page.

If the web page item is part of a group of web page items having group-level style properties applied to all items in the group, selectively changing a style property for an individual style property in the group disables the group-level style properties for the group to allow the selected change to be made to the selected web page item. However, according to embodiments of the present invention, style properties applied to other items of the associated group of items are maintained as dictated by the group-level style properties prior to disabling the group-level style properties. That is, selectively changing a style property for one item in the group of web page items does not cause that style property to be applied to all items in the group. On the other hand, if desired, a web page author/editor may apply a group-level style property to a group of web page items according to embodiments of the present invention by highlighting a group of web page items prior to selecting application of a style property as described herein.

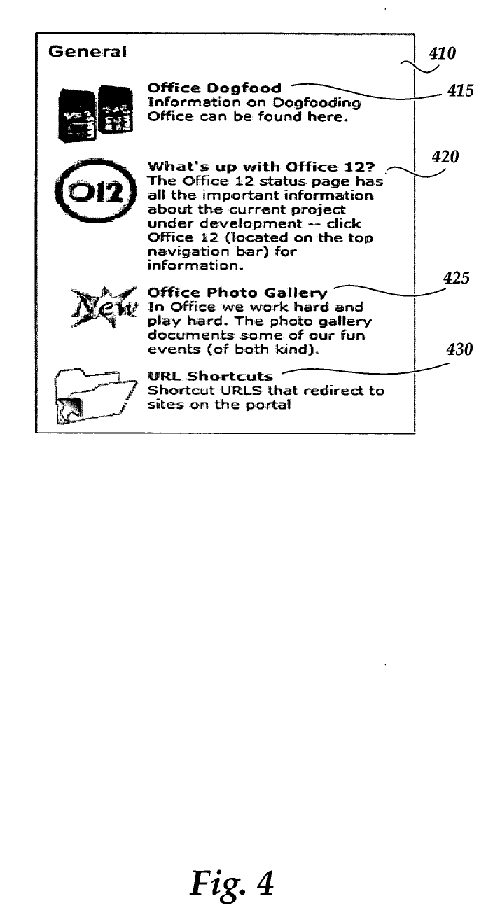

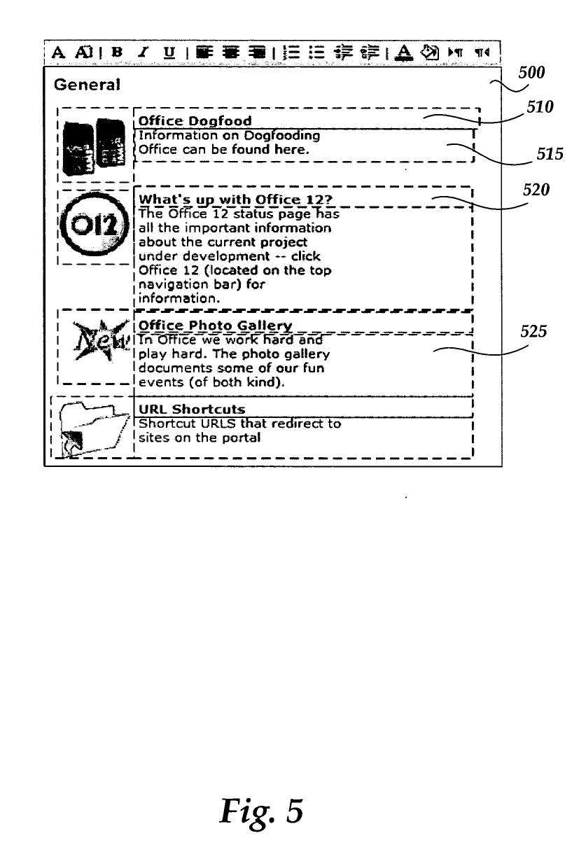

As described with reference to FIGS. 2 and 3, style properties may be applied to one or more web page items through the use of an edit menu 300. Alternatively, as described below with reference to FIGS. 4 and 5, style properties applied to web page items may also be edited through a web page user interface for placing all items on a given web page into an editing mode. Referring to FIG. 4, an example web page 410 is illustrated showing a number of web page parts 415, 420, 425, 430. Each of the example web page parts includes an image, a title, and an item description. As should be understood by those skilled in the art, the web page parts illustrated in FIG. 4 are for purposes of illustration only and are not limiting of the vast number of different web page items that may be included in the web page 410. Referring to FIG. 5, a web page author/editor may place the web page 410 into an edit mode by selecting a web page user interface 500 for making edits to various web page parts contained on the web page 410. For example, the author/editor may select a button or tool from the web browsing application such as “configure styles,” “edit web page,” or the like.

Upon selecting an edit mode, the web user interface 500 is provided as illustrated in FIG. 5. According to one embodiment, each editable element or portion of the web page items contained on the web page 410 is outlined in a dashed line, and the author/editor may make individual edits in an HTML-editor like fashion. For example, individual elements may be dragged and dropped through a drag and drop operation from one area of the web page to another. For example, the description 515 under the title 510 may be dragged from its present location to a different position on the web page, followed by a dropping action for depositing the dragged description to the second location. In addition, if a user having sufficient editing rights rearranges the content of a web page item via a drag/drop operation, and thus changes the presentation style, for example, moving the image from the left of the title/description, illustrated in FIG. 5, to the right of the title/description, the associated style property is updated, and all other web page items using that style are likewise updated. For a detailed description of reorganizing web page components via a drag/drop mechanism, see United States Patent Application, entitled “Organizing Elements On A Web Page Via Drag And Drop Operations, serial number ________, applicant matter number 310779.01, attorney/agent matter number 14917.0054US01, filed Mar. 18, 2005, which is incorporated herein by reference as if fully set out herein.

If a portion of a web page item, such as the description 515, is dragged from its present location to a second location, according to embodiments of the present invention, the presentation level information, including the dragged text, and all underlying information, such as metadata and coding associated with the operability of the dragged item are moved to the drop location. If a style property is applied to the dragged web page item, as described above with reference to FIGS. 2 and 3, the style property, along with the associated XSL style definition file, moves with the dragged web page item to the drop location. If the drop location is not associated with a previously established style setting, then the style property associated with the dragged web page item remains with the dragged web page item, and the web page item is styled according to the previously applied style setting in its new (dropped) location.

According to one embodiment, if the dragged web page item is dropped into a group of web page items bearing a group-level style setting, the group-level style setting controls, and the XSL style definitions applied to the group-level web page items are automatically applied to the dropped item. For example, if a dragged item having a title formatted according to a bold text formatting style is dropped in a group of web page items having titles formatted according to an italicized formatting style, the dropped item will be automatically reformatted according to the XSL style definition applied to the group-level web page items, and the dropped item will be reformatted according to the example italicized formatting style.

According to an alternative embodiment, if a web page item is dragged to a group of web page items having an applied group-level style setting (e.g., one or more style properties), the group-level style setting may be broken, and the dropped item may retain the style properties applied to the dropped item from its starting location. According to this alternative embodiment, all other items in the group of web page items retain style properties applied to those items as a part of the original group-level style properties. If the author/editor then desires to edit the style properties associated with the dropped item, the author/editor may utilize the edit menu 300 described above with respect to FIG. 3. In addition to the drag and drop operations described above, once the web page 410 is in an edit mode in the web editing user interface 500, style settings may be applied to or revised for various portions of the web page items by highlighting text or images and by applying style properties, for example, font types and sizes, colors, alignments, and the like, via the toolbar functions provided by the user interface 500 (i.e., web page editing application).

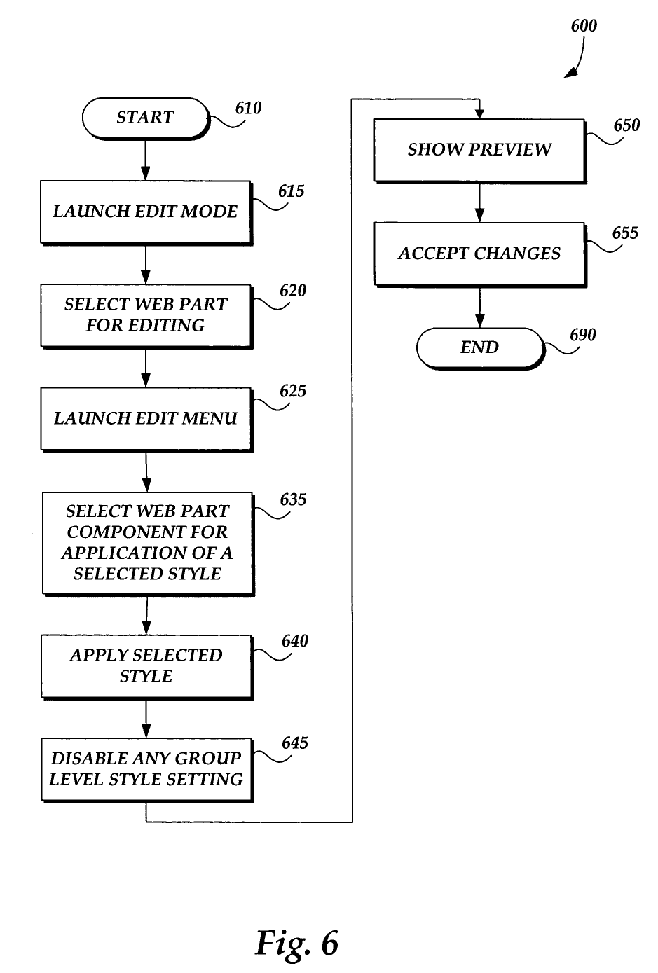

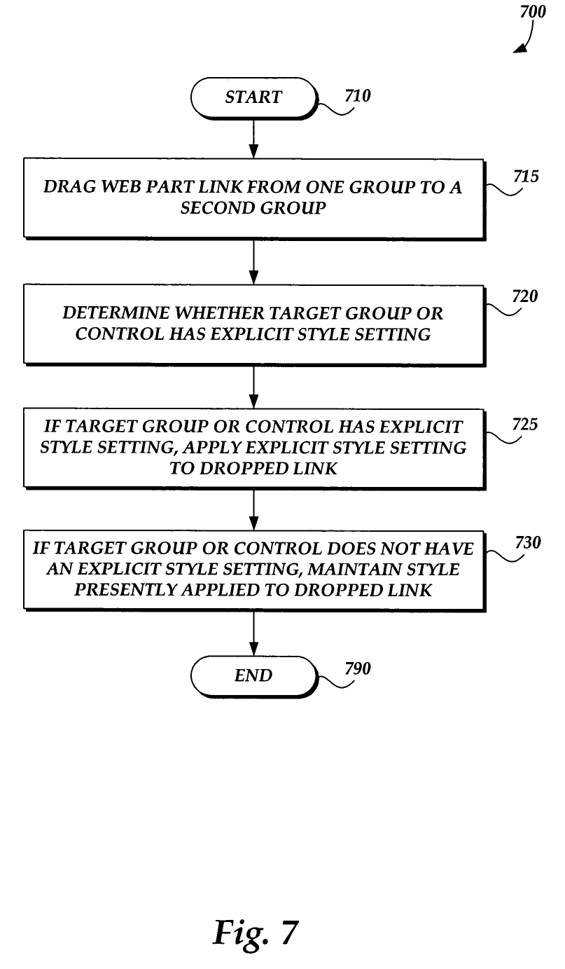

Having described an exemplary operating environment and various embodiments and aspects of the present invention, FIGS. 6 and 7 illustrate routines for applying style properties to web page items according to embodiments of the present invention. FIG. 6 is a flow diagram showing an illustrative routine for editing style properties applied to web page items via an edit menu described above with reference to FIGS. 2 and 3. Referring to FIG. 6, the routine 600 begins at start block 610 and proceeds to block 615 where a web page author/editor desiring to edit one or more web page items of a web page 200 launches an edit mode as described above with reference to FIGS. 2 and 3. At block 620, the author/editor selects a particular web page item for editing which causes the edit menu entry point 220 to be displayed about the selected web page item. If desired, the author/editor may select all items in a given web page control or area for application of one or more style properties as described below.

At block 625, the edit menu 300 is deployed for application of a desired style property to the selected web page item. At block 635, a web page style property is selected for application of a selected style property. For example, from the style window 310, a style property, such as “title,” “bullet and title,” or the like may be selected for application of a selected style property. At block 640, a selected style property, for example, “bullet and title” may be selected for application to the selected web item.

At block 645, if the selected style property is being applied to a web page item that is part of a group of web items, any group-level style settings applied to the group of web page items is disabled, and the selected style setting is applied to the selected web item, but style settings previously applied to other web items in the group by the group-level setting are maintained by the other web part items.

At block 650, a preview of application of the selected style property is provided in the preview window 320 to allow the author/editor, to preview the result of application of the selected style property to the selected web item. If the author/editor approves of the style property preview, the author/editor may accept the applied style property at block 655, and the applied style property will be applied to the associated web item in the web page 200. Alternatively, if the author/editor does not approve of the previewed style property application, the author/editor may repeat the operations described with respect to blocks 635 through 650 until the author/editor is satisfied with the application of one or more selected style properties. The routine ends at block 690.

FIG. 7 is a flow diagram showing an illustrative routine for applying style properties to web page items via a web page editing application and via drag and drop operations. Referring to FIG. 7, the routine 700 begins at start block 710 where a web page author/editor decides to edit one or more web page items or web page item components of a web page 410 using a web page editing user interface 500, as described above with reference to FIGS. 4 and 5. At block 715, if the web page author decides to move a web page item, such as a web page link, from a first location in the web page 410 to a second location in the web page 410, the author/editor drags the selected web page item from one web page group to a second web page group or from a first location on the web page to a second location on the web page.

At block 720, a determination is made as to whether the target group or target location or control has an explicit style setting previously applied to the target location, target group, or target control. At block 725, if the target group, target control or target location has an explicit style setting, the explicit style setting is applied to the dropped web item. At block 730, if the target group, control, or location does not have an explicit style setting, then application of the style setting presently applied to the dropped link or other web item is maintained in the target control, group, or location. The routine ends at block 790.

As described herein, methods and systems provide for application of style properties/settings to one or more web page items, components, links, or other web page content. Use of an edit menu allows for the application of a selected style setting on a per-item basis or on an all-item basis and allows for the provision of a preview of the application of a selected style setting to a selected web page item. Through the use of a web page editing user interface, style settings may be applied to web page items through drag and drop operations and through application via conventional style setting application methods such as highlighting a selected web page item, followed by selection of a desired style setting. It will be apparent to those skilled in the art that various modifications or variations may be made in the present invention without departing from the scope or spirit of the invention. Other embodiments of the invention will be apparent to those skilled in the art from consideration of the specification and practice of the invention disclosed here.

We claim:

1. A method for applying style properties to items on a web page; comprising:
receiving a selection of a given web page item;
providing one or more style properties that may be applied to the selected web page item;
receiving a selection of one of the one or more style properties for application to the selected web page item; and
providing a preview of the selected web page item with application of the selected style property to the selected web page item.

2. The method of claim 1, further comprising applying the selected style property to the selected web page item in the web page.

3. The method of claim 2, whereby if the selected web page item is part of a group of web page items having an applied group-level style property, disabling the group-level style property and allowing application of the selected style property to the selected web page item.

4. The method of claim 3, whereby for any other web page item in the group of web page items, maintaining a previously applied style property as applied according to the group-level style property.

5. The method of claim 1, prior to receiving a selection of a given web page item, further comprising:
receiving a web page containing one or more web page items; and
receiving a selection of placing the web page into an edit mode for editing one or more web page items.

6. The method of claim 5, further comprising providing an edit menu entry point for deploying an edit menu for allowing application of one or more style properties to selected page items.

7. The method of claim 6, further comprising:
receiving a selection for deploying the edit menu; and
providing the edit menu.

8. The method of claim 7, whereby receiving a selection of one of the one or more style properties for application to the selected web page item includes receiving a selection of one of the one or more style properties for application to the selected web page item from the edit menu.

9. The method of claim 8, whereby providing a preview of the selected web page item with application of the selected style property to the selected web page item includes providing the preview in the edit menu.

10. The method of claim 9, prior to applying the selected style property to the selected web page item, receiving a selection in the edit menu for accepting the application of the selected style property to the selected web page item.

11. The method of claim 10, after applying the selected style property to the selected web page item in the web page, dismissing the edit menu.

12. A method for applying style properties to items on a web page; comprising:
receiving a selection of a given web page item from a web page;
dragging the selected web page item from a first position on the web page to a second position on the web page; and
if the second position is associated with a previously set style property for web page items located at the second position, applying the previously set style property to the selected web page item if the selected web page item is dropped at the second position.

13. The method of claim 12, prior to dragging the selected web page item from a first position on the web page to a second position on the web page, receiving a selection of placing the web page into an edit mode for editing one or more web page items.

14. The method of claim 12, prior to applying the previously set style property to the selected web page item if the selected web page item is dropped at the second position, determining whether the second position is associated with a previously set style property for web page items located at the second position.

15. The method of claim 12, whereby if the second position is not associated with a previously set style property for web page items located at the second position, maintaining any style properties previously applied to the selected web page item after the selected web page item is dropped at the second position in the web page.

16. A computer-readable medium having stored thereon computer-executable instructions which when executed by a computer perform a method for applying style properties to items on a web page; comprising:
receiving a selection of a given web page item;
providing one or more style properties that may be applied to the selected web page item;
receiving a selection of one of the one or more style properties for application to the selected web page item;
providing a preview of the selected web page item with application of the selected style property to the selected web page item; and
applying the selected style property to the selected web page item in the web page.

17. The computer-readable medium of claim 16, whereby if the selected web page item is part of a group of web page items having an applied group-level style property, disabling the group-level style property and allowing application of the selected style property to the selected web page item.

18. The computer-readable medium of claim 17, whereby for any other web page item in the group of web page items, maintaining a previously applied style property as applied according to the group-level style property.

19. The computer-readable medium of claim 16, after receiving a selection of a given web page item further comprising:
providing an edit menu;
whereby receiving a selection of one or more portions of the selected web page item for application of a selected style property includes receiving the selection of one or more portions of the selected web page item from the edit menu; and
whereby providing a preview of the selected web page item with application of the selected style property to the selected portion of the selected web page item includes providing the preview in the edit menu.

20. The computer-readable medium of claim 19, prior to applying the selected style property to the selected web page item, receiving a selection in the edit menu for accepting the application of the selected style property to the selected web page item.
